(19) United States
(12) Patent Application Publication
(10) Pub. No.: US 2015/0269485 A1
(43) Pub. Date: Sep. 24, 2015

(54) COLD NEURON SPIKE TIMING BACK-PROPAGATION

(71) Applicant: QUALCOMM Incorporated, San Diego, CA (US)

(72) Inventors: David Jonathan JULIAN, San Diego, CA (US); Sachin Subhash TALATHI, San Diego, CA (US)

(21) Appl. No.: 14/486,757

(22) Filed: Sep. 15, 2014

Related U.S. Application Data
(60) Provisional application No. 61/969,752, filed on Mar. 24, 2014.

(51) Int. Cl. G06N 3/08; G06F 17/11

(52) U.S. Cl. CPC G06N 3/084; G06F 17/11

(57) ABSTRACT

Neuron state updates are computed with spiking models with map based updates and at least one reset mechanism. Back propagation is applied on spike times to compute weight updates.

### CROSS-REFERENCE TO RELATED APPLICATION

This application claims the benefit under 35 U.S.C. §119(e) to U.S. Provisional Patent Application No. 61/969,752, entitled “COLD NEURON SPIKE TIMING BACK PROPAGATION,” filed on Mar. 24, 2014, the disclosure of which is expressly incorporated by reference herein in its entirety.

### BACKGROUND

1. Field

Certain aspects of the present disclosure generally relate to neural system engineering and, more particularly, to back propagation in neural networks.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

Training a neural network may include training “in reverse” in which an output is manipulated by manipulating the inputs. This method of training is useful for categorization and for instances where forward propagation may have errors. By propagating the errors from output to input in a neural network, the network may learn to classify and/or identify groups or other common features within the network. Such a “backward propagation of errors” is referred to as “back propagation.” Thus, it is desirable to provide a neuromorphic receiver that can incorporate back propagation.

### SUMMARY

A method in accordance with an aspect of the present disclosure includes computing neuron state updates with spiking models with map based updates and at least one reset mechanism. The method further includes using back propagation on spike times to compute weight updates.

An apparatus for performing back propagation in a spiking neural network in accordance with another aspect of the present disclosure includes means for computing neuron state updates with spiking models with map based updates and at least one reset mechanism. Such an apparatus also includes means for using back propagation on spike times to compute weight updates.

A computer program product for performing back propagation in a spiking neural network in accordance with another aspect of the present disclosure includes a non-transitory computer readable medium having encoded thereon program code. The program code includes program code to compute neuron state updates with spiking models with map based updates and at least one reset mechanism. The program code further includes program code to use back propagation on spike times to compute weight updates.

An apparatus for performing back propagation in a spiking neural network in accordance with another aspect of the present disclosure includes a memory and at least one processor coupled to the memory. The processor(s) is configured to compute neuron state updates with spiking models with map based updates and at least one reset mechanism. The processor(s) is also configured to use back propagation on spike times to compute weight updates.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike timing dependent plasticity (STDP) curve in accordance with certain aspects of the present disclosure.

FIG. 4A illustrates an example of a positive regime and a negative regime for defining behavior of a neuron model in accordance with certain aspects of the present disclosure.

FIG. 4B illustrates a spike timing diagram in accordance with an aspect of the present disclosure.

FIG. 5 illustrates an example implementation of designing a neural network using a general-purpose processor in accordance with certain aspects of the present disclosure.

FIG. 6 illustrates an example implementation of designing a neural network where a memory may be interfaced with individual distributed processing units in accordance with certain aspects of the present disclosure.

FIG. 7 illustrates an example implementation of designing a neural network based on distributed memories and distributed processing units in accordance with certain aspects of the present disclosure.

FIG. 8 illustrates an example implementation of a neural network in accordance with certain aspects of the present disclosure.

FIG. 9 is a block diagram illustrating back propagation in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

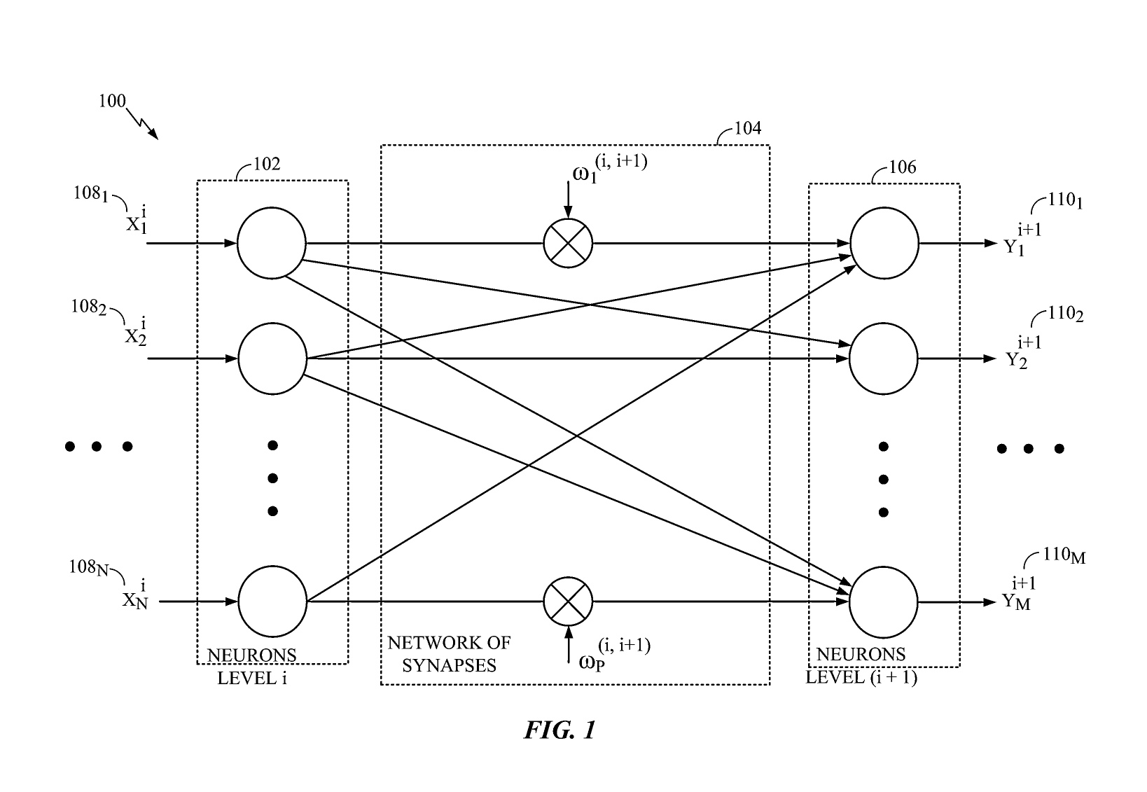

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The input signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

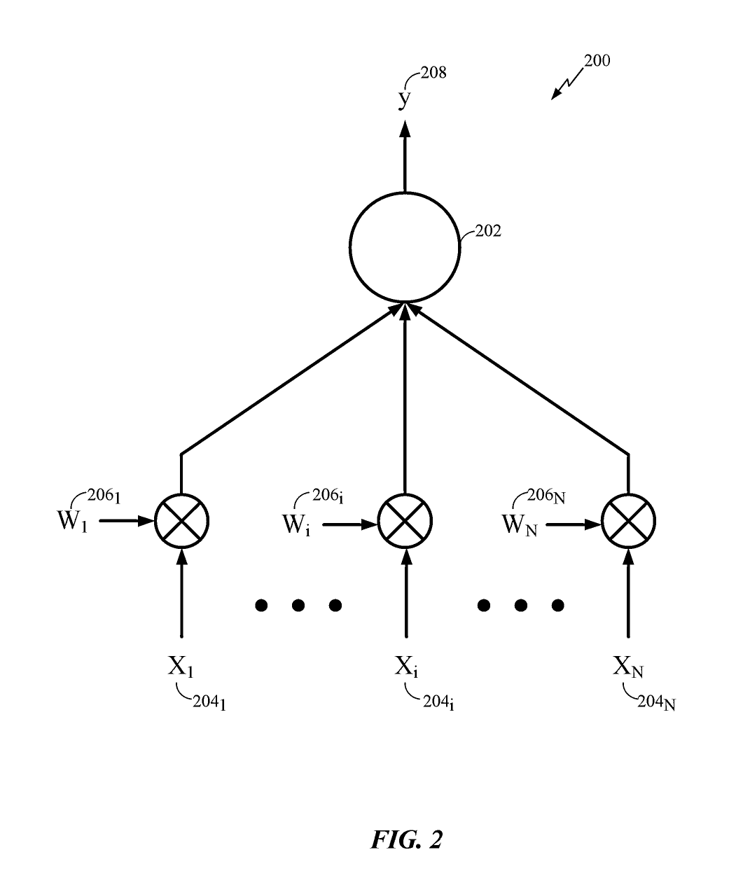

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 2041-204N, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 2061-206N (W1-WN), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 2061-206N from FIG. 2) may be initialized with random values and increased or decreased according to a learning rule. Those skilled in the art will appreciate that examples of the learning rule include, but are not limited to the spike timing dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not use plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike timing dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike timing dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , & t > 0 \\ {a}_{-} {e}^{t / {k}_{-}} , & t < 0\end{matrix} , \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

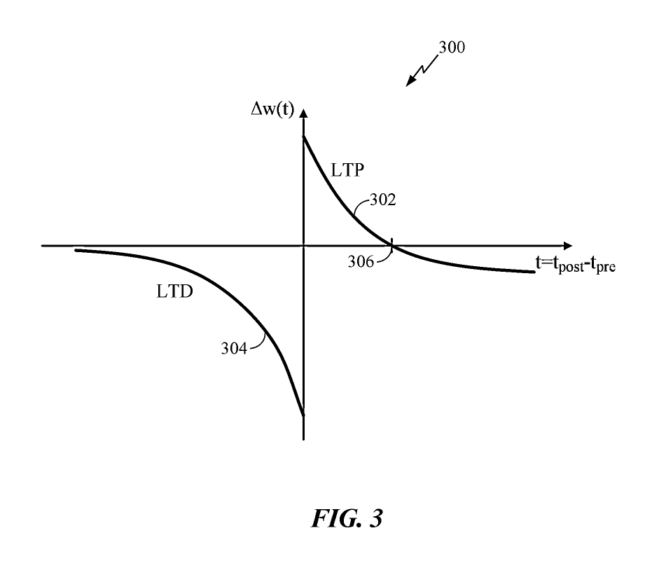

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

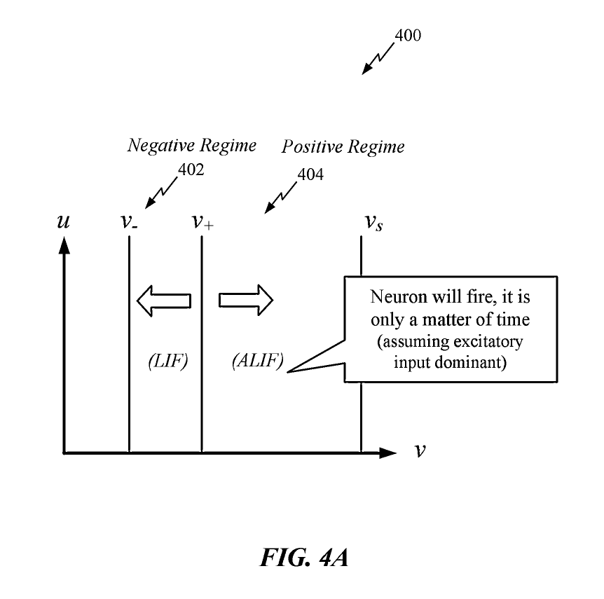

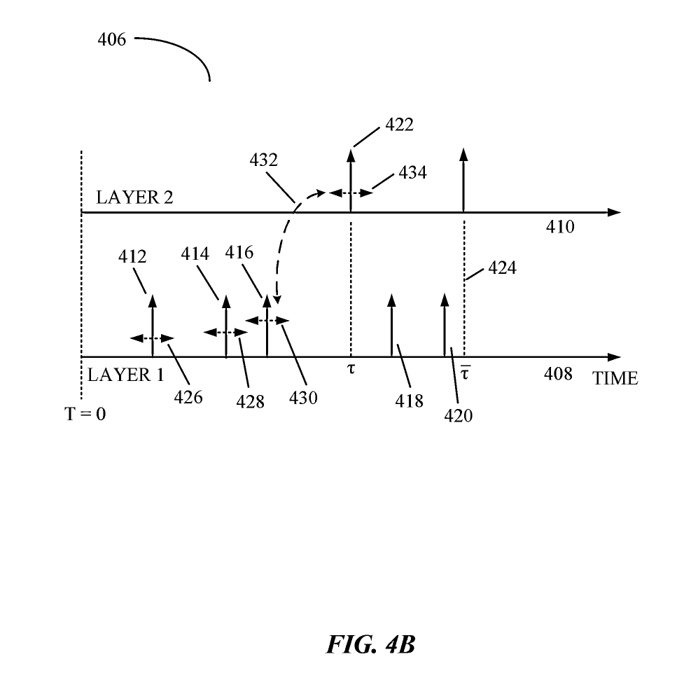

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{β} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value vₛ. Subsequently, the state may be reset at a reset event (which may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time to reach a particular state. The close form state solutions are:

$$\begin{matrix}v ( t + Δ t ) = ( v ( t + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ, then the closed-form solution for the amount of time, or relative delay, until a spike occurs as measured from the time that the voltage is at a given state v is:

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily utilize iterative methods or Numerical methods. An event-based implementation is also possible at a limited time resolution in a step-based simulator by only updating the model if an event occurs at or between steps or by “step-event” update.

The inputs to a neural network may come from various sources. For example, inputs may be events that occur during a specific time period. Further, inputs may be two-dimensional (2-D) representations of a three-dimensional (3-D) object in a defined space. Output events or spikes may also be events during a specific time period. For example, in the 2-D/3-D example above, the output events may be a third coordinate of the 3-D object in the defined space. A sensor, such as an address event representation camera, may supply the input events.

### Cold Neuron Spike Timing Back Propagation

An aspect of the present disclosure is directed to training a multilayer spiking neural network using back propagation. In addition, certain heuristics are defined to address cases in which the gradient is undefined (e.g., neurons are not firing or are firing too weakly). Accordingly, using back propagation in conjunction with the described heuristics allows for computing weight changes in the neural network including regions in which the gradient is undefined and thus provides enhancements in training the neural network.

In an aspect of the present disclosure, a multilayer spiking neural network uses 1-D computationally-efficient linear two-dimensional (COLD) neurons with back propagation to perform classification and regression tasks. Other neuron models, such as the LIF model, the ALIF model, the Exponential Integrate-and-Fire model, the Hodgkin-Huxley model, the FitzHugh-Nagumo model, the Morris-Lecar model, the Hindmarsh-Rose model, and/or other spiking or non-spiking neuron models may be used with the present disclosure. A collection of these models may be referred to as “map-based” models herein. For example, a map-based update may be based on a difference equation, a differential equation, a look-up table, a state machine update, or other approaches.

When back propagation is used in spiking neural networks, there are regions of error gradients that may be undefined or zero. Many models avoid back propagation techniques because of these errors. The present disclosure provides approaches for asymptotically approaching the local minimum for back propagation of error gradients.

In an aspect of the present disclosure, the multilayer gradient back propagation is used with one-dimensional COLD (model) neurons. For certain portions of the COLD neuron model, heuristics where the gradients are not well defined are incorporated in the back propagation approach. These heuristics include cases when neurons are not firing for any training cases or are firing too weakly, when the membrane voltage potential is too strong which makes the error gradient zero, and accounting for a wider range of error gradients that may be present in the COLD model. Because the COLD model has a discontinuity between the LIF and ALIF regions, the present disclosure also provides methods for resolving this gradient discontinuity.

FIG. 4B illustrates a spike timing diagram in accordance with an aspect of the present disclosure. A timing diagram 406 illustrates a first layer 408 and a second layer 410 of neurons. The first layer 408 acts as an input to the second layer 410. As neurons 412-420 in the first layer 408 fire, the neuron 422 in the second layer 410 fires based on the inputs received from the neurons 412-420. The first layer 408 and the second layer 410 may be the only two layers in a neural network, or may be any two other consecutive layers in a neural network. As such, the discussion that refers to the second layer 410 may also apply to the first layer 408, and vice versa. Moreover, both the first layer 408 and the second layer 410 may be hidden layers in the neural network of the present disclosure.

Because a neural network may be causal (i.e., the neural network works in a time-dependent fashion where outputs in the second layer 410 can only depend on previous inputs from the first layer 408), the output of the neuron 422 can only depend on the inputs received from the neurons 412, 414, and 416.

Further, the output of the neuron 422, at time t=T, may not be at the desired output time. If the desired output time is at time t=f, shown as desired output time 424 (which may be referred to as the target output time), the output of the neuron 422 moves in time towards the desired output time 424. This delay can be implemented by increasing the weights assigned to the synapses upon which the inputs from the neurons 412-416 are received, or by shifting the inputs from the neurons 412-416 in time. This shift in time and/or weighting is indicated by arrows 426-430. This movement of the inputs of the neurons 412-416 and/or the changing of the weights associated with the inputs of the neurons 412-416 are shown as an effect 432, which moves the output of the neuron 422 as indicated by the arrow 434.

As the output of the neuron 422 moves toward the desired output time 424, additional inputs from the neurons 418 and/or 420 may be reflected in the output of the neuron 422. Further, as the output of the neuron 422 moves in time toward the desired output time 424, the movement of the output of the neuron 422 may not be linear, may move past the desired output time 424, or may be undefined at a certain position as the weights and/or times of the outputs of the neurons 412-420 are changed. The present disclosure provides methods for controlling the movement of the output of the neuron 422 toward the desired output time 424.

A first aspect of the present disclosure provides a method for modifying the output of the neuron 422 when it is not firing at all or is firing too weakly. In such an aspect, the weights associated with the outputs of the neurons 412-416 may be changed by a constant value, a variable value, or a random value, and the output of the neuron response is observed. The weights are then adjusted based on an amount of change in the timing of the output of the neuron 422. From the timing diagram 406, the weights of the outputs of the neurons 412-416 may be increased or decreased to move the output of the neuron 422. Further, because the first layer 408 may be receiving inputs from another layer in the neural network, the outputs of the neurons 412-416 may also be moved in time to affect the output time of the output of the neuron 422.

There will also be occurrences when changing the weights and/or times of the outputs of the neurons 412-416 does not affect the time of the output of the neuron 422. This is symptomatic of the membrane voltage potential being too strong, which makes the error gradient zero. In an aspect of the present disclosure, the weights of the outputs of the neurons 412-416 may be changed by a constant, which may be a fixed constant, a variable constant, or a random constant, and the change in the timing of the output of the neuron 422 observed. The outputs of the neurons 412-416 may be decreased to increase the sensitivity of the output of the neuron 422 to inputs from the neurons 412-416.

In another aspect of the present disclosure, the membrane voltage distance from a peak voltage may be determined, and the constant used to change the weights of the outputs of neurons 412-416. The weights of the outputs of the neurons 412-416 may be changed as a function of the distance in firing times between the outputs of the neurons 412-416 and the output of the neuron 422. In another aspect of the disclosure, a constant, which may be referred to as a barrier penalty function, may be added to the gradient computation for the weights assigned to outputs of the neurons 412-416.

The neural network may also take into account a wider range of gradients for one map-based model as compared with another. For example, the COLD model may have a wider range of error gradients as compared with artificial neural network (ANN) networks. With wider error gradients, a small change in error gradient may not appreciably move the timing of the output of the neuron 422, or may move the timing of the output of the neuron 422 too much. As such, the learning rate of such a model may be very slow or never have a local minimum. The present disclosure also provides methods for incorporating a wider range of gradients while maintaining reasonable learning rates for the model of the neural network.

If the error gradients are above a threshold value (e.g., 0.5), then a constant change in the error gradient weights may not asymptotically approach the desired output time 424. Normalization of the gradients when the gradient error values exceed a threshold will provide a smoother approach to the desired output time 424. Further, saturating (maximizing) the weights for certain outputs that are greater than a threshold may also more rapidly move the output of the neuron 422 toward the desired output time 424.

Because the COLD model integrates features of the leaky integrate and fire/anti-leaky integrate and fire (LIF/ALIF) models, the present disclosure provides methods for handling the discontinuity/undefined gradients at the boundary between these models. The present disclosure may, for example, compute the error gradients as if the discontinuity is not present or did not exist. Further, the present disclosure may use a smoothly varying approximation near the discontinuity, and/or use a conditional gradient where the computed gradient is based on the error detection.

### Heuristics for COLD Model in Back Propagation

The Cold gradient has large regions with values of 0 and critical points at v+(i.e., the threshold at which neuron dynamics change in the COLD model). These areas between the LIF/ALIF portions of the COLD model is where the gradient is undefined/infinite (e.g., where neuron dynamics prevent neurons from firing or create a neuron that is firing near the threshold value or at the wrong time (a “weakly” firing neuron)). These potential gradients may cause the back propagation to become unable to provide useful approaches to determining the proper weights, or may prevent the back propagation from asymptotically reducing the gradient error.

Accordingly, using back propagation in conjunction with heuristics in accordance with an aspect of the present disclosure allows for computing weight changes in the neural network. The weight (synapse weighting) may include regions in which the gradient is undefined and thus provides enhancements in training the neural network. The present disclosure also provides for training a multilayer spiking neural network using one-dimensional (1-D) computationally-efficient linear two-dimensional (COLD) neurons with back propagation to perform classification and regression tasks. The present disclosure also provides solutions for running back propagation in spiking neural networks where the gradients are undefined or zero, the neuron dynamics have discontinuities, and/or the membrane voltages are too strong.

COLD model back propagation may use “gradient descent” when the gradient is non-zero and defined. There are several heuristics that describe events that may affect the back propagation of the present disclosure. The heuristics for such undefined/zero gradients may be processed in any order. In an aspect of the present disclosure, the heuristics may be processed in a specific order, such as that presented herein.

Initially, a membrane voltage potential (synaptic weight) may be too weak. If no input neurons are spiking, then it is not possible for the output neuron to spike. In such a case, the input neuron gradient is set to zero to avoid making weight changes for a layer when there is no information on which to base weight those weight changes. Lower layer weight changes may be determined so that eventually input neurons will start to fire based on applying rules to those layers. As such, the initial neuron gradient is set as follows:

Δwᵢⱼ=0 (15)

Next, if the output neuron does not spike, this is called a “weakly spiking” case, and the input neuron gradient may be set to a default, or a random amount, as follows:

ΔWᵢⱼ=Δ_{default} (16)

If the output neuron does not spike at all then the gradients may be nonexistent, and all the weights should be increased by a small amount. The weights may be increased by an amount proportional to vₚₗᵤₛ−maxₙ vₙₚ because this is the amount that the membrane voltage may be increased to activate the gradients again.

In an aspect of the present disclosure, the default or random gradient value may be set only for those synapses with inputs, or may be set for all synapses if desired.

Next, a hidden neuron may be spiking at a time later than tₚ and t̅ₚ (the target output spike time and the maximum target output spike time, respectively), which is also considered a “weakly firing” neuron condition. In such cases, the hidden neuron gradients, and/or the input neuron gradients, may also be set to a default or random value.

Next, conditions where the membrane potential is too strong are considered. For such conditions, the synaptic weights of firing neurons may be decreased by a fixed or a variable constant. The variable constant may be determined in several ways. In one aspect, the variable constant may be determined by the distance between the membrane voltage to the peak voltage. In another aspect, the variable constant may be determined as a function of the distance between firing times.

Other conditions related to synaptic weights occur because of the timing of arriving spikes and the spiking of a particular neuron. If a neuron spikes at an input spike time, then it is not possible for the output neuron to properly attribute the weight of the input neuron in relation to the spike from the output neuron. Such a condition is considered “too strong” of a synaptic weight, and may be redefined as follows:

(v_{Np}>vₚₑₐₖ):Δwᵢⱼ=Δ_{default}ê(|tₚ−tₕ_{ᵢ}|/τ₊) (17)
where V_{Np} is the membrane potential when the neuron spikes, vₚₑₐₖ is the membrane potential to generate a spike, Δ_{default} is a parameter chosen to provide a relative weighting to the gradient computation and to other gradient computations, tₚ is the time when the neuron spiked, tₕᵢ is the time input spike time of the ith input, and τ₊ is the cold neuron parameter.

If the last spike causes the output neuron to fire first (v_{\hat{N}p}>vₚₑₐₖ so that tₚ=t_{\hat{N}p}) then the gradients are nonexistent. In this case, each of the synaptic weights may be decreased by a small amount. The weights may be decreased by an amount proportional to v_{\hat{N}p}−vₚₑₐₖ because this is the amount that the final membrane voltage may be reduced by to get the gradients active again.

The primary heuristic causing issues may be too strong of output, which results in zero gradient and a heuristic of decreasing all the weights. A barrier regularization function may be added so that the gradient would be defined for too strong of an output and that gradient could be back propagated and proportional to the overshoot.

As such, the weights for each of the synapses with inputs are each evaluated to properly determine the weight for each synapse/input neuron.

When a neuron has a membrane voltage near the LIF/ALIF dynamics threshold voltage (v+) when a spike arrives, the present disclosure may compute the error gradient ignoring this discontinuity in dynamics. In another aspect, a barrier penalty function may be added to the gradient computation near the LIF/ALIF threshold voltage.

In such an aspect of the present disclosure, once these heuristics have been evaluated and exhausted for the neural network, a gradient exists for each synapse and the undefined/infinite gradient conditions have been defined in terms of the COLD model. As such, the present disclosure modifies the reduction of the average squared error, and provides some initial approaches (e.g., assumptions) regarding the causes for the output spike.

The present disclosure also may normalize gradients and then apply the gradients in a given direction towards the desired output solution. However, this may not reduce the learning rate for the neural network and make convergence to a local minimum difficult as gradients become smaller. Smaller gradients will then receive smaller and smaller normalizations, which will increase learning time.

To overcome this problem, the present disclosure may normalize gradients that are larger than a threshold, or have large magnitudes or elements, or may limit gradient weight updates in large directions, to reduce or even minimize the asymptotic problem with normalization.

Further, the present disclosure also provides a smooth transition from LIF to ALIF regions using a sigmoid function.

### Mathematics for Back Propagation in the 1-D COLD Model

The I-D COLD Model follows the form:

$$\dot{v} = \frac{1}{{τ}_{ρ}} v - {v}_{ρ} + I ( t ) \qquad ( 18 )$$

If only delta input currents exist, i.e.:

$$I ( t ) = {\sum }_{j = 1}^{J} {w}_{j} δ ( t - {t}_{j} ) \qquad ( 19 )$$

A closed form event solution is as follows:

$${v}_{j + 1} = {e}^{\frac{{t}_{j + 1} - {t}_{j}}{{τ}_{{ρ}_{j}}}} {v}_{j} + ( 1 - {e}^{\frac{{t}_{j + 1} - {t}_{j}}{{τ}_{{ρ}_{j}}}} ) {v}_{ρ} + {w}_{j + 1} \qquad ( 20 )$$

where vⱼ₊₁ is the voltage after the j+1 spike arrival with weight wⱼ₊₁.

To minimize the expected error function E=(tₚ− t̅ₚ)² where tₚ is the actual output spike time and t̅ₚ is the target output spike time, the weights, wᵢⱼ, may be optimized. The gradients for gradient descent

$$( Δ {w}_{ij} = - \frac{\partial E}{\partial {w}_{ij}} )$$

may be computed when the ALIF dynamics cause the output neurons first spike as:

$$\begin{matrix}\begin{matrix} \frac{\partial E}{\partial {w}_{np}} = \frac{\partial E}{\partial {t}_{p}} \frac{\partial {t}_{p}}{\partial {w}_{np}} \\ = {δ}_{p} {y}_{np}\end{matrix} \\ where & ( 21 ) \\ \begin{matrix} {δ}_{p} = \frac{\partial E}{\partial {t}_{p}} \\ = ( {t}_{p} - {\overline{t}}_{p} )\end{matrix} \\ and & ( 22 ) \\ {y}_{np} = \{ \begin{matrix}( \frac{- {τ}_{+}}{{V}_{Np}^{+} - {V}_{+}} ) {e}^{{\sum }_{i} ( {t}_{i + 1} - {t}_{i} ) / {τ}_{{ρ}_{i}}} & if {V}_{{N}_{p}}^{+} < {V}_{peak} and {t}_{n} \leq {t}_{Np} \\ 0 & otherwise\end{matrix} & ( 23 )\end{matrix}$$

For the hidden layers,

$$\begin{matrix} \begin{matrix}\frac{\partial E}{\partial {w}_{mn}} = \frac{\partial E}{\partial {t}_{n}} \frac{\partial {t}_{n}}{\partial {w}_{mn}} \\ = {δ}_{n} {y}_{mn} \\ = ( {δ}_{p} {y}_{np} {γ}_{np} ) {y}_{mn}\end{matrix} \\ where & ( 24 ) \\ {γ}_{np} = \frac{- 1}{{τ}_{{ρ}_{n}}} ( {V}_{n}^{+} - {V}_{{ρ}_{n}} ) + \frac{- 1}{{τ}_{{ρ}_{n - 1}}} {e}^{( {t}_{n} - {t}_{n - 1} ) / {τ}_{{ρ}_{n - 1}}} ( {V}_{n - 1}^{+} - {V}_{{ρ}_{n - 1}} ) \\ and & ( 25 ) \\ {y}_{mn} = \{ \begin{matrix}( \frac{- {τ}_{+}}{{V}_{\hat{M} n}^{+} - {V}_{+}} ) {e}^{{\sum }_{i} ( {t}_{i + 1} - {t}_{i} ) / {τ}_{{ρ}_{i}}} & if {V}_{\hat{M} n}^{+} < {V}_{peak} and {t}_{m} \leq {t}_{\hat{M} n} \\ 0 & otherwise\end{matrix} & ( 26 )\end{matrix}$$

This led to revising the error function from:

E(tₚ)=0.5(tₚ− t̅ₚ)² (27)

to equation (28):

$$E ( {t}_{p } ) = 0.5 {( {t}_{p} - {\overline{t}}_{p} )}^{2} + {ψ}_{o} 0.5 {( {v}_{o} ( {t}_{p} ) - {v}_{peak} )}^{2} + {ψ}_{h} {\sum }_{n}^{ } 0.5 {( {v}_{{h}_{n}} ( {t}_{n} ) - {v}_{peak} )}^{2} \qquad ( 28 )$$

where vₒ(tₚ) is the output neuron membrane voltage at the spike time tₚ, and so (vₒ(tₚ)−vₚₑₐₖ)² is the square of how much it exceeds the spiking threshold vₚₑₐₖ. If the last arriving input spike at time t_{N} resulted in the output neuron membrane voltage below vₚₑₐₖ thus the ALIF dynamics caused the spike then vₒ(tₚ)=vₚₑₐₖ and the error term is zero. Otherwise, if the last spike caused it to exceed the threshold, which under the original error function would result in an error gradient of zero because small weight changes would generally not affect the spike time, then the barrier will add to the error by the amount ψₒ(vₒ(tₚ)−vₚₑₐₖ)².

Similarly, the gradients for the input to hidden neurons would be zero without a barrier, so the ψₕΣₙ(vₕ_{ₙ}(tₙ)−vₚₑₐₖ)² term is a barrier penalty to encourage the hidden neurons not to have too strong outputs.

By redefining the error function with the barrier regularization terms the back propagation algorithm may be re-derived and the too strong output heuristic is now part of the back propagation.

The back propagation is computed as follows. For the output layer, the gradient of the first term, (tₚ− t̅ₚ)², is the same as in equation (28), and the third term, ψₕΣₙ 0.5 (vₕ_{ₙ}(tₙ)−vₚₑₐₖ)², which is based on the hidden node spike times is not a function of the hidden to output weights, wₙₚ, and so its gradient is zero. That leaves the middle term computed as:

$$\frac{\partial {ψ}_{o} 0.5 {( {v}_{o} ( {t}_{p} ) - {v}_{peak} )}^{2}}{\partial {w}_{np}} = {ψ}_{o} ( v ( {t}_{p} ) - {v}_{peak} ) ( \frac{\partial {v}_{o} ( {t}_{p} )}{\partial {w}_{np}} ) \qquad ( 29 )$$

If tₚ≠t_{N}, the last spike time, then

$${v}_{o} ( {t}_{p} ) = {v}_{peak}$$

$$and$$

$$\frac{\partial {v}_{o} ( {t}_{p} )}{\partial {w}_{np}} = 0.$$

Otherwise:

$$\frac{\partial {v}_{o} ( {t}_{p} )}{\partial {w}_{np}} = \frac{\partial {v}_{N}}{\partial {w}_{np}} \qquad ( 30 )$$

which was computed in equation (23) using the chain rule as:

$$\frac{\partial {v}_{N}}{\partial {w}_{np}} = {\prod }_{i = n}^{( N - 1 )} {e}^{\frac{{t}_{i + 1} - {t}_{i}}{{τ}_{{ρ}_{i}}}} \qquad ( 31 )$$

So define:

$${z}_{np} = {ψ}_{o} ( v ( {t}_{p} ) - {v}_{peak} ) {\prod }_{i = n}^{( N - 1 )} {e}^{\frac{{t}_{i + 1} - {t}_{i}}{{τ}_{{ρ}_{i}}}} \qquad ( 32 )$$

And in the notation of equation (28), δₚ=(tₚ− t̅ₚ), and:

$${y}_{np} = \{ \begin{matrix}( \frac{- {τ}_{+}}{{V}_{{N}_{p}}^{+} - {V}_{+}} ) {e}^{{Σ}_{i} ( {t}_{i + 1} - {t}_{i} ) / {τ}_{{ρ}_{i}}} & if {V}_{{N}_{p}}^{+} < {V}_{peak} and {t}_{n} \leq {t}_{Np} \\ 0 & otherwise\end{matrix} \qquad ( 33 )$$

the output layer barrier error gradient is:

$$\frac{\partial E}{\partial {w}_{np}} = {δ}_{p} {y}_{np} + {z}_{np} \qquad ( 34 )$$

For the hidden layers, the error gradient

$$\frac{\partial E}{\partial {w}_{mn}}$$

will have three parts, the back propagated error from the first two terms and the error from the third term, ψₕΣₙ 0.5 (vₕ_{ₙ}(tₙ)−vₚₑₐₖ)². The error from the third term will be zₘₙ computed the same way as for the output layer. The back propagation of the first term is the same as in equation (23). The back propagation of the second term is computed as:

$$\begin{matrix}\frac{\partial {ψ}_{o} 0.5 {( {v}_{o} ( {t}_{p} ) - {v}_{peak} )}^{2}}{\partial {w}_{mn}} = {ψ}_{o} ( v ( {t}_{p} ) - {v}_{peak} ) ( \frac{\partial {v}_{o} ( {t}_{p} )}{\partial {w}_{mn}} ) \\ = {ψ}_{o} ( v ( {t}_{p} ) - {v}_{peak} ) ( \frac{\partial {v}_{o} ( {t}_{p} )}{\partial {t}_{n}} \frac{\partial {t}_{n}}{\partial {w}_{mn}} ) \\ = {ψ}_{o} ( v ( {t}_{p} ) - {v}_{peak} ) ( \frac{\partial {v}_{o} ( {t}_{p} )}{\partial {t}_{n}} {y}_{mn} ) \\ = {ψ}_{o} {z}_{np} {γ}_{np} {y}_{mn}\end{matrix} \qquad ( 35 )$$

Using the same technique and definition as from equation (28):

$$( 36 )$$

$${γ}_{np} {=}^{Δ} \frac{( \frac{d {v}_{( n + 1 ) p}}{d {t}_{n}} )}{( \frac{\partial {v}_{( n + 1 ) p} \partial {v}_{np}}{\partial {v}_{np} \partial {w}_{np}} )} = \frac{- 1}{{τ}_{{ρ}_{n}}} ( {V}_{n}^{+} - {V}_{{ρ}_{n}} ) + \frac{- 1}{{τ}_{{ρ}_{n - 1}}} {e}^{\frac{{t}_{n} - {t}_{n - 1}}{{τ}_{{ρ}_{n - 1}}}} ( {V}_{n - 1}^{+} - {V}_{{ρ}_{n - 1}} )$$

The output layer back propagation gradients with the barrier are then given by:

$$\begin{matrix} \frac{\partial E}{\partial {w}_{np}} = \frac{\partial E}{\partial {t}_{p}} \frac{\partial {t}_{p}}{\partial {w}_{np}} = {δ}_{p} {y}_{np} + {ψ}_{o} {z}_{np} where & ( 37 ) \\ {δ}_{p} = \frac{\partial E}{\partial {t}_{p}} = ( {t}_{p} - {\overline{t}}_{p} ) and & ( 38 ) \\ {y}_{np} = \{ \begin{matrix}( \frac{- {τ}_{+}}{{V}_{{N}_{p}}^{+} - {V}_{+}} ) {e}^{{Σ}_{i} ( {t}_{i + 1} - {t}_{i} ) / {τ}_{{ρ}_{i}}} & if {V}_{{N}_{p}}^{+} < {V}_{peak} and {t}_{n} \leq {t}_{Np} \\ 0 & otherwise\end{matrix} and & ( 39 ) \\ {z}_{np} = {ψ}_{o} ( v ( {t}_{p} ) - {v}_{peak} ) {\prod }_{i = n}^{( N - 1 )} {e}^{( {t}_{i + 1} - {t}_{i} ) / {τ}_{{ρ}_{i}}} & ( 40 )\end{matrix}$$

The hidden layer gradients with the barrier are:

$$\begin{matrix}\frac{\partial E}{\partial {w}_{mn}} = \frac{\partial E}{\partial {t}_{n}} \frac{\partial {t}_{n}}{\partial {w}_{mn}} = {δ}_{n} {y}_{mn} + {ψ}_{h} {z}_{mn} = \{ \begin{matrix}( {δ}_{p} + {ψ}_{o} {z}_{np} ( \frac{1}{{τ}_{{ρ}_{N - 1}}} {e}^{\frac{{t}_{N} - {t}_{N - 1}}{{τ}_{{ρ}_{N - 1}}}} ( {V}_{N - 1}^{+} - {V}_{{ρ}_{N - 1}} ) ) ) {y}_{mn} + {ψ}_{h} {z}_{mn} & if n = N and {v}_{N} > {v}_{peak} \\ ( ( {δ}_{p} {y}_{np} + {ψ}_{o} {z}_{np} ) {γ}_{np} ) {y}_{mn} + {ψ}_{h} {z}_{mn} & otherwise\end{matrix} \\ where & ( 41 ) \\ {γ}_{np} = \frac{- 1}{{τ}_{{ρ}_{n}}} ( {V}_{n}^{+} - {V}_{{ρ}_{n}} ) + \frac{1}{{τ}_{{ρ}_{n - 1}}} {e}^{( {t}_{n} - {t}_{n - 1} ) / {τ}_{{ρ}_{n - 1}}} ( {V}_{n - 1}^{+} - {V}_{{ρ}_{n - 1}} ) and & ( 42 ) \\ {y}_{mn} = \{ \begin{matrix}( \frac{- {τ}_{+}}{{V}_{\hat{M} n}^{+} - {V}_{+}} ) {e}^{{Σ}_{i} ( {t}_{i + 1} - {t}_{i} ) / {τ}_{{ρ}_{i}}} & if {V}_{\hat{M} n}^{+} < {V}_{peak} and {t}_{m} \leq {t}_{\hat{M} n} \\ 0 & otherwise\end{matrix} and & ( 43 ) \\ {z}_{mn} = {ψ}_{h} ( {v}_{n} ( {t}_{n} ) - {v}_{peak} ) {\prod }_{i = m}^{( M - 1 )} {e}^{\frac{{t}_{i + 1} - {t}_{i}}{{τ}_{{ρ}_{i}}}} & ( 44 )\end{matrix}$$

The present disclosure seeks to reduce or even minimize the average squared error:

$$E = \frac{1}{2} {\sum }_{i} {( {t}_{{p}_{i}} - {\overline{t}}_{{p}_{i}} )}^{2} \qquad ( 45 )$$

where tₚ_{ᵢ} is the first output spike time after input sequence i and t̅ₚ_{ᵢ} is the desired spike time based on the class label of sequence i.

The present disclosure seeks to minimize the expected error function E=(tₚ− t̅ₚ)² where tₚ is the actual output spike time and t̅ₚ is the target output spike time by improving or, if possible, optimizing the weights, wᵢⱼ. For this derivation, t̅ₚ is greater than the last input spike time. This may not be needed, but does remove the gradient discontinuity from an incoming spike causing the output spike time.

### Output Layer

To perform gradient descent:

$$Δ {w}_{ij} = - η \frac{\partial E}{\partial {w}_{ij}} \qquad ( 46 )$$

a back propagation gradients may define that the ALIF region “drift” causes output spikes if desired. “Drift” means that the ALIF neuron dynamics cause the neuron to spike rather than a spike arrival, i.e., V_{Np}=vₚₑₐₖ.

For a gradient descent

$$( Δ w = - \frac{\partial E}{\partial {w}_{np}} ) ,$$

the output layer is computed by determining

$$\frac{\partial E}{\partial {w}_{np}} ,$$

the partial derivative or the error function with respect to the weight from hidden node n to the output node p as:

$$\begin{matrix} \frac{\partial E}{\partial {w}_{np}} = \frac{\partial E}{\partial {t}_{p}} \frac{\partial {t}_{p}}{\partial {w}_{np}} = {δ}_{p} {y}_{np} , {δ}_{p} = \frac{\partial E}{\partial {t}_{p}} = ( {t}_{p} - {\overline{t}}_{p} ) where & ( 47 ) \\ {y}_{np} = \{ \begin{matrix}( \frac{- {τ}_{+}}{{V}_{{N}_{p}}^{+} - {V}_{+}} ) {e}^{{Σ}_{i} \frac{{t}_{i + 1} - {t}_{i}}{{τ}_{{ρ}_{i}}}} & if {V}_{{N}_{p}}^{+} < {V}_{peak} and {t}_{n} \leq {t}_{Np} \\ 0 & otherwise\end{matrix} & ( 48 )\end{matrix}$$

As in other back propagation approaches, the yₙₚ term may be computed in a forward pass, and the δₚ term may be computed in a backward pass.

The Output Layer δₚ is computed as:

$${δ}_{p} = \frac{\partial E}{\partial {t}_{p}} = ( {t}_{p} - {\overline{t}}_{p} ) \qquad ( 49 )$$

Following a similar approach, the yₙₚ term is computed using the chain rule over the spike arrival times as:

$${y}_{np} = \frac{\partial {t}_{p}}{\partial {w}_{np}} = \frac{\partial {t}_{p}}{\partial {V}_{\hat{N} p}} ( \frac{\partial {V}_{\hat{N} p}}{\partial {V}_{( \hat{N} - 1 ) p}} ) ( \frac{\partial {V}_{( \hat{N} - 1 ) p}}{\partial {V}_{( \hat{N} - 2 ) p}} ) … ( \frac{\partial {V}_{( n + 1 ) p}}{\partial {V}_{np}} ) ( \frac{\partial {V}_{np}}{\partial {w}_{np}} ) \qquad ( 50 )$$

Where V_{\hat{N}p} is the membrane potential right after the last spike arrival before the output neuron spikes at time tₚ.

Given the Cold LIF/ALIF dynamics, the neuron should be in the ALIF regime for V_{\hat{N}p} because the neuron spikes without further spike arrivals. So tₚ may be computed as a function of V_{\hat{N}p} by setting ρ=+, vⱼ=v_{\hat{N}p}, vⱼ₊₁=Vₚₑₐₖ, tⱼ=t_{\hat{N}p}, tⱼ=tₚ, and wⱼ₊₁=0 and solving for tₚ. wⱼ₊₁=0. These conditions simulate the event where a spike did not arrive at the time the neuron fired. Solving the equation gives:

$${t}_{p} = {t}_{{\hat{N}}_{p}} + {τ}_{+} ln ( \frac{{v}_{peak} - {v}_{+}}{{v}_{{\hat{N}}_{p}} - {v}_{+}} ) \qquad ( 51 )$$

Taking the partial derivative with respect to V_{\hat{N}p} gives

$$\frac{\partial {t}_{p}}{\partial {v}_{\hat{N} p}} = \frac{- {τ}_{+}}{{v}_{\hat{N} p} - {v}_{+}} \qquad ( 52 )$$

Further, differentiating with respect to

$$\frac{\partial {V}_{np}}{\partial {w}_{np}} gives \frac{\partial {V}_{np}}{\partial {w}_{np}} = 1 ,$$

which reduces the equation to y_{\hat{N}p}.

To compute the other yₙₚ values

$$\frac{\partial {V}_{( n + 1 ) p}}{\partial {v}_{np}}$$

is computed in general by differentiating, this time with respect to vₙₚ to get:

$$\frac{\partial {V}_{( n + 1 ) p}}{\partial {V}_{np}} = {e}^{\frac{{t}_{n + 1} - {t}_{n}}{{τ}_{{ρ}_{n}}}} \qquad ( 53 )$$

Putting these together gives:

$$\begin{matrix}{y}_{np} = ( \frac{- {τ}_{+}}{{V}_{{N}_{p}}^{+} - {V}_{+}} ) {\prod }_{i = n}^{( \hat{N} - 1 )} {e}^{( {t}_{i + 1} - {t}_{i} ) / {τ}_{{ρ}_{i}}} \\ = ( \frac{- {τ}_{+}}{{V}_{{N}_{p}}^{+} - {V}_{+}} ) {e}^{{\sum }_{i} ( {t}_{i + 1} - {t}_{i} ) / {τ}_{{ρ}_{i}}}\end{matrix} \qquad ( 54 )$$

This is for the cases when ALIF dynamics take the membrane voltage over the threshold. In the case when an arriving spike takes the membrane voltage over the threshold, then

$$\frac{\partial {t}_{p}}{\partial {V}_{\hat{N} p}} = 0$$

because the voltage is over the threshold by more than an epsilon amount. In such a case, all of the

$${y}_{np} = 0 since \frac{\partial {t}_{p}}{\partial {V}_{\hat{N} p}}$$

is common to all of the gradient terms.

Similarly, for the purposes of one output target spike, t̅ₚ, any spikes arriving after the last spike will cause the first spike to have a zero gradient on the first spiking time. This condition gives:

$${y}_{np} = \{ \begin{matrix}( \frac{- {τ}_{+}}{{V}_{{N}_{p }}^{+} - {V}_{+}} ) {e}^{{\sum }_{i} \frac{{t}_{i + 1} - {t}_{i}}{{τ}_{{ρ}_{i}}}} & if {V}_{{N}_{p}}^{+} < {V}_{peak} and {t}_{n} \leq {t}_{Np} \\ 0 & otherwise\end{matrix} \qquad ( 55 )$$

### Hidden Layer

The hidden layer spiking may be determined by:

$$\begin{matrix}\begin{matrix}\frac{\partial E}{\partial {w}_{mn}} = \frac{\partial E}{\partial {t}_{n}} \frac{\partial {t}_{n}}{\partial {w}_{mn}} \\ = {δ}_{n} {y}_{mn} \\ = ( {δ}_{p} {y}_{np} {γ}_{np} ) {y}_{mn}\end{matrix} \\ where & ( 56 ) \\ {γ}_{np} = \frac{- 1}{{τ}_{{ρ}_{n}}} ( {V}_{n}^{+} - {V}_{{ρ}_{n}} ) + \frac{- 1}{{τ}_{{ρ}_{n - 1}}} {e}^{( {t}_{n} - {t}_{n - 1} ) / {τ}_{{ρ}_{n - 1}}} ( {V}_{n - 1}^{+} - {V}_{{ρ}_{n - 1}} ) & ( 57 )\end{matrix}$$

For hidden layer gradient descent, the present disclosure computes

$$\frac{\partial E}{\partial {w}_{mn}} .$$

Using the chain rule as above:

$$\begin{matrix}\frac{\partial E}{\partial {w}_{mn}} = \frac{\partial E}{\partial {t}_{n}} ( \frac{\partial {t}_{n}}{\partial {w}_{mn}} ) \\ = {δ}_{n} {y}_{mn}\end{matrix} \qquad ( 58 )$$

For the hidden layer δₙ further expansion using the chain rule gives:

$$\begin{matrix}{δ}_{n} = \frac{\partial E}{\partial {t}_{n}} \\ = \frac{\partial E}{\partial {t}_{p}} \frac{\partial {t}_{p}}{\partial {t}_{n}} \\ = {δ}_{p} \frac{\partial {t}_{p}}{\partial {t}_{n}}\end{matrix} \qquad ( 59 )$$

where δₚ=(tₚ− t̅ₚ) was computed previously for the output layer, and

$$\frac{\partial {t}_{p}}{\partial {t}_{n}}$$

is the impact of a change in the hidden neuron n spiking time on the output layer spiking time.

When the nth spike arrives at a time before tₚ it contributes to the first output spike time and does not cause it to exceed the threshold. In such cases

$$\frac{\partial {t}_{p}}{\partial {t}_{n}}$$

is computed using the chain rule as

$$\frac{\partial {t}_{p}}{\partial {t}_{n}} = \frac{\partial {t}_{p}}{\partial {v}_{\hat{N} p}} ( {\prod }_{k = \hat{N}}^{n + 2} \frac{\partial {v}_{kp}}{\partial {v}_{( k - 1 ) p}} ) ( \frac{d {v}_{( n + 1 ) p}}{d {t}_{n}} ) \qquad ( 60 )$$

Comparing the above equation for

$$\frac{\partial {t}_{p}}{\partial {t}_{n}}$$

with the chain rule expansion for yₙₚ,

$$\frac{\partial {t}_{p}}{\partial {t}_{n}}$$

may be written in terms of yₙₚ by defining a new term γₙₚ as:

$$\frac{\partial {t}_{p}}{\partial {t}_{n}} = {y}_{np} {γ}_{np} \qquad ( 61 )$$

Where:

$${γ}_{np} {=}^{Δ} \frac{( \frac{d {v}_{( n + 1 ) p}}{d {t}_{n}} )}{( \frac{\partial {v}_{( n + 1 ) p}}{\partial {v}_{np}} \frac{\partial {v}_{np}}{\partial {w}_{np}} )}$$

For vⱼ₊₁, with j=n, taking the derivative with respect to tₙ gives:

$$\frac{d {v}_{( n + 1 ) p}}{d {t}_{n}} = - \frac{1}{{τ}_{{ρ}_{n}}} {e}^{\frac{( {t}_{n + 1} - {t}_{n} )}{{τ}_{{ρ}_{n}}}} ( {v}_{n} - {v}_{{ρ}_{n}} ) + {e}^{\frac{( {t}_{n + 1} - {t}_{n} )}{{τ}_{{ρ}_{n}}}} \frac{d {v}_{np}}{d {t}_{n}} \\ \frac{d {v}_{( n + 1 ) p}}{d {t}_{n}} = - \frac{1}{{τ}_{{ρ}_{n}}} {e}^{\frac{( {t}_{n + 1} - {t}_{n} )}{{τ}_{{ρ}_{n}}}} ( {v}_{np} - {v}_{{ρ}_{n}} ) + {e}^{\frac{( {t}_{n + 1} - {t}_{n} )}{{τ}_{{ρ}_{n}}}} ( \frac{1}{{τ}_{ρ ( n - 1 )}} {e}^{\frac{( {t}_{n} - {t}_{n - 1} )}{{τ}_{{ρ}_{n - 1}}}} ( {v}_{( n - 1 ) p} - {v}_{{ρ}_{n - 1}} ) ) \qquad ( 62 )$$

Also, for vⱼ₊₁, with j=n and taking the derivative with respect to vₙₚ gives:

$$\frac{\partial {v}_{( n + 1 ) p}}{\partial {v}_{np}} = {e}^{\frac{( {t}_{n + 1} - {t}_{n} )}{{τ}_{{ρ}_{n}}}}$$

Finally, taking the partial derivative for vⱼ₊₁ with j=n−1 gives:

$$\frac{\partial {v}_{np}}{\partial {w}_{np}} = 1$$

Substituting these three terms into the equation for γₙₚ gives:

$${γ}_{np} = - \frac{1}{{τ}_{{ρ}_{n}}} ( {v}_{np} - {v}_{{ρ}_{n}} ) + \frac{1}{{τ}_{{ρ}_{( n - 1 )}}} {e}^{\frac{( {t}_{n} - {t}_{n - 1} )}{{τ}_{{ρ}_{n - 1}}}} ( {v}_{( n - 1 ) p} - {v}_{{ρ}_{n - 1}} ) \qquad ( 63 )$$

If n=\hat{N} is the last spike and it causes the voltage to immediately exceed the threshold, v_{\hat{N}p}>vₚₑₐₖ then

$$\frac{\partial {t}_{p}}{\partial {t}_{\hat{N}}} = 1$$

and all other

$$\frac{\partial {t}_{p}}{\partial {t}_{n}} = 0$$

as a small shift in the last input spike time will cause the output spike to shift by that same amount as it caused the output spike time and small shifts in the other spike times will not impact the output spike time. In this instance,

$${y}_{np} = 0 , \\ so$$

$$\frac{\partial {t}_{p}}{\partial {t}_{n}} = 0$$

automatically,

$$so$$

$$\frac{\partial {t}_{p}}{\partial {t}_{\hat{N}}} = 1$$

explicitly.

The hidden layer yₘₙ is identical to the output layer, so the equation is the same, except that the spike time is the hidden node spike time and the voltage is the hidden node last input spike voltage:

$${y}_{mn} = \{ \begin{matrix}( \frac{- {τ}_{+}}{{V}_{\hat{M} n}^{+} - {V}_{+}} ) {e}^{{\sum }_{i} ( {t}_{i + 1} - {t}_{i} ) / {τ}_{{ρ}_{i}}} & if {V}_{\hat{M} n}^{+} < {M}_{peak} and {t}_{m} \leq {t}_{\hat{M} n} \\ 0 & otherwise\end{matrix} \qquad ( 64 )$$

For the hidden layer, neuron spiking is given by:

$$\begin{matrix}\frac{\partial E}{\partial {w}_{mn}} = \frac{\partial E}{\partial {t}_{n}} \frac{\partial {t}_{n}}{\partial {w}_{mn}} \\ = {δ}_{n} {y}_{mn} + {ψ}_{h} {z}_{mn}\end{matrix} \qquad ( 65 )$$

An artificial neural network perception output layer gradient may be given as follows:

(y−ŷ)x is linear in x and y. (66)

For xε{±10} and yε{±20} Gradε{±200}, a learning rate of η=10⁻⁴ will have small step sizes for largest gradients (200), and still reasonable step sizes for small gradients (i.e., 1 or 0.1).

A COLD neural network output layer gradient may be given as follows:

$$( {t}_{p} - {\overline{t}}_{p} ) = ( \frac{- {τ}_{+}}{{v}_{\hat{M} n}^{+} - {v}_{+}} ) {e}^{{\sum }_{i} ( {t}_{i + 1} - {t}_{i} ) / {τ}_{{ρ}_{i}}} \qquad ( 67 )$$

where tₚ˜y, t̅ₚ˜ŷ, and Σᵢ(tᵢ₊₁−tᵢ)˜x.

As such, the COLD gradient is approximately (y−ŷ)Ce^{αx}, which is exponential in x.

For xε{+10} and yε{±20} and a=1, Gradε{±4×10⁵} for some x, but may be on the order of 1 or smaller for small values, so the cold gradients cover orders of magnitude making selecting a learning rate difficult. To overcome this deficiency, the present disclosure may normalize the gradients by taking small or normalized gradient changes (“steps”) in the gradient direction.

If taking small steps in the gradient direction does not reduce the learning rate, then the present disclosure may only normalize gradients with large magnitudes or elements, or may limit weighting updates in large directions. For example, and not by way of limitation, a smooth transition between the LIF and ALIF regions using a sigmoid function may be employed as follows:

τ_{ρ(v}_{ⱼ}₎=σ(a(vⱼ−v₊))τ₊+(1−σ(a(vⱼ−v₊)))τ₋,similarly for v_{ρ(v}_{ⱼ}₎ (68)

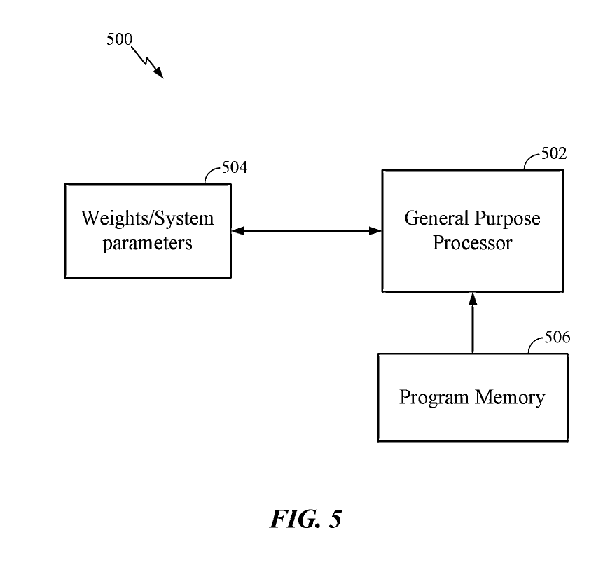

FIG. 5 illustrates an example implementation 500 of the aforementioned back propagation using a general-purpose processor 502 in accordance with certain aspects of the present disclosure. Variables (neural signals), synaptic weights, system parameters associated with a computational network (neural network), delays, and frequency bin information may be stored in a memory block 504, while instructions executed at the general-purpose processor 502 may be loaded from a program memory 506. In an aspect of the present disclosure, the instructions loaded into the general-purpose processor 502 may comprise code for obtaining error gradients for prototypical neuron dynamics and/or modifying parameters of a neuron model so that the neuron model matches the prototypical neuron dynamics.

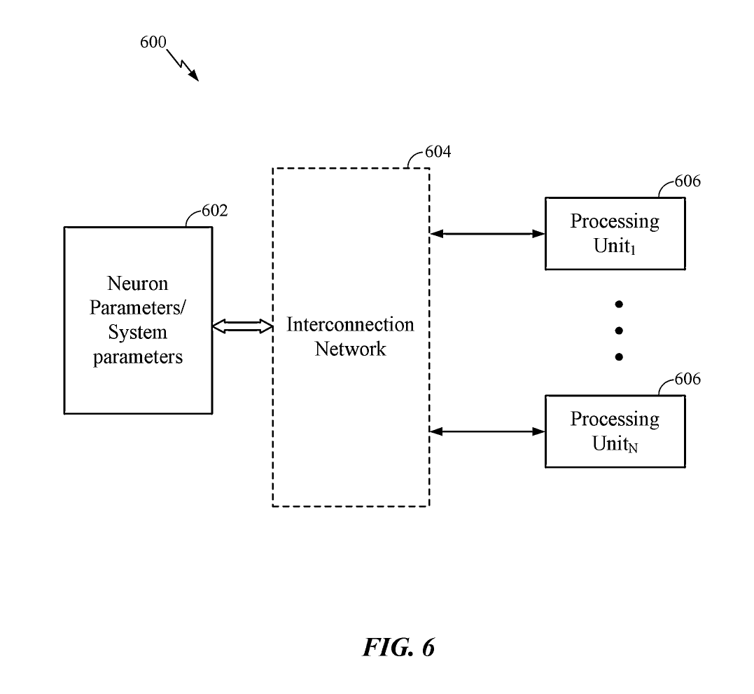

FIG. 6 illustrates an example implementation 600 of the aforementioned back propagation where a memory 602 can be interfaced via an interconnection network 604 with individual (distributed) processing units (neural processors) 606 of a computational network (neural network) in accordance with certain aspects of the present disclosure. Variables (neural signals), synaptic weights, system parameters associated with the computational network (neural network) delays, frequency bin information, back propagation, etc., may be stored in the memory 602, and may be loaded from the memory 602 via connection(s) of the interconnection network 604 into each processing unit (neural processor) 606. In an aspect of the present disclosure, the processing unit 606 may be configured to obtain error gradients for prototypical neuron dynamics and/or modify parameters of a neuron model.

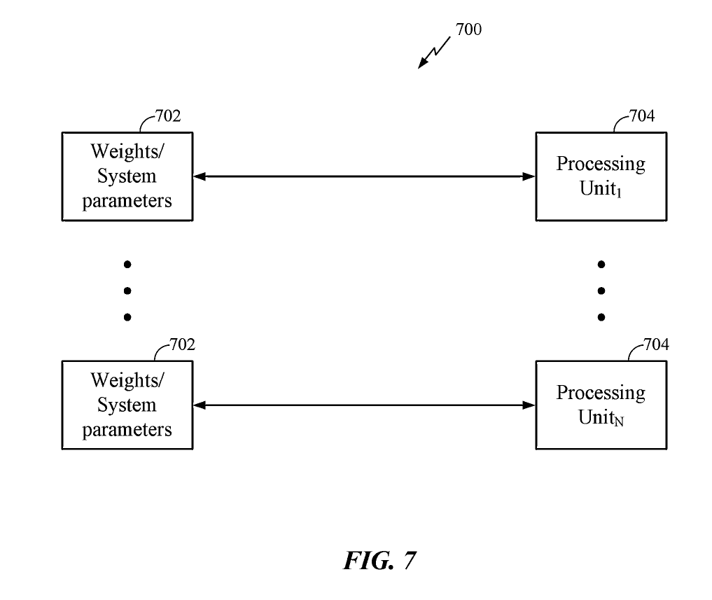

FIG. 7 illustrates an example implementation 700 of the aforementioned back propagation. As illustrated in FIG. 7, one memory bank 702 may be directly interfaced with one processing unit 704 of a computational network (neural network). Each memory bank 702 may store variables (neural signals), synaptic weights, and/or system parameters associated with a corresponding processing unit (neural processor) 704 delays, frequency bin information, back propagation, etc. In an aspect of the present disclosure, the processing unit 704 may be configured to obtain error gradients for prototypical neuron dynamics and/or modify parameters of a neuron model.

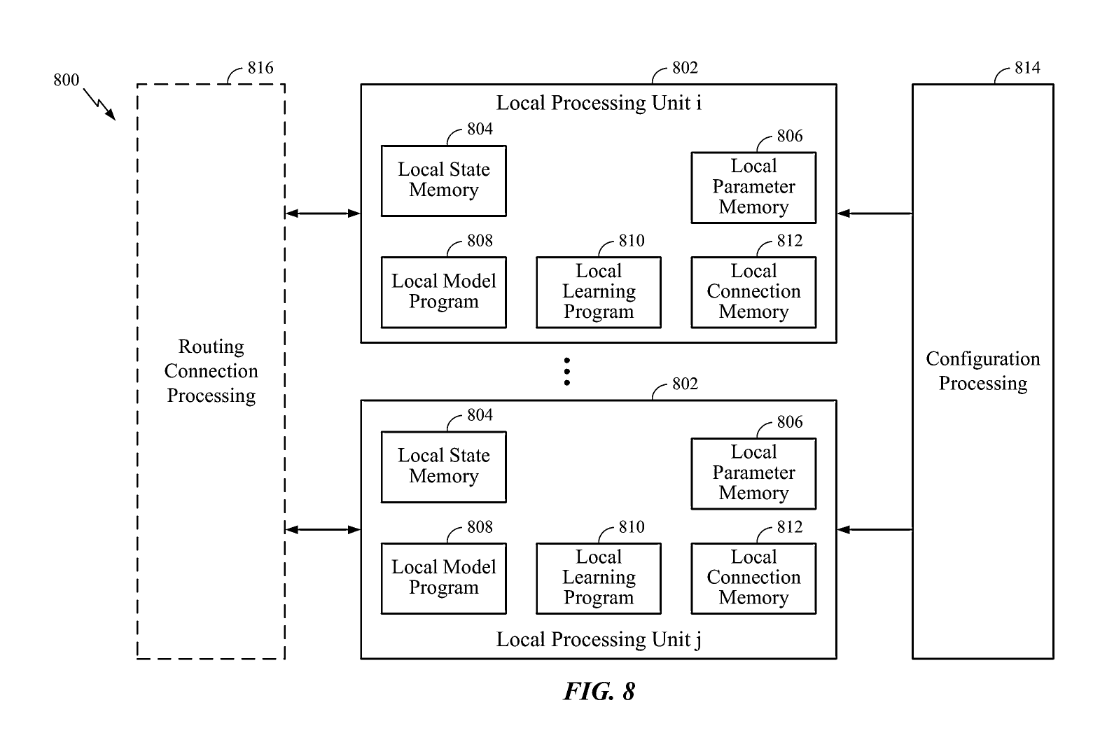

FIG. 8 illustrates an example implementation of a neural network 800 in accordance with certain aspects of the present disclosure. As illustrated in FIG. 8, the neural network 800 may have multiple local processing units 802 that may perform various operations of methods described above. Each local processing unit 802 may comprise a local state memory 804 and a local parameter memory 806 that store parameters of the neural network. In addition, the local processing unit 802 may have a local (neuron) model program (LMP) memory 808 for storing a local model program, a local learning program (LLP) memory 810 for storing a local learning program, and a local connection memory 812. Furthermore, as illustrated in FIG. 8, each local processing unit 802 may be interfaced with a configuration processor unit 814 for providing configurations for local memories of the local processing unit, and with a routing connection processing unit 816 that provide routing between the local processing units 802.

In one configuration, a neuron model is configured for obtaining error gradients for prototypical neuron dynamics and/or modifying parameters of a neuron model. The neuron model includes means for computing neuron state updates with spiking models with map-based updates and at least one reset mechanism, and means for using back propagation on spike times to compute weight updates. In one aspect, the computing means and/or the using means may be the general-purpose processor 502, program memory 506, memory block 504, memory 602, interconnection network 604, processing units 606, processing unit 704, local processing units 802, and or the routing connection processing units 816 configured to perform the functions recited. In another configuration, the aforementioned means may be any module or any apparatus configured to perform the functions recited by the aforementioned means.

According to certain aspects of the present disclosure, each local processing unit 802 may be configured to determine parameters of the neural network based upon desired one or more functional features of the neural network, and develop the one or more functional features towards the desired functional features as the determined parameters are further adapted, tuned and updated.

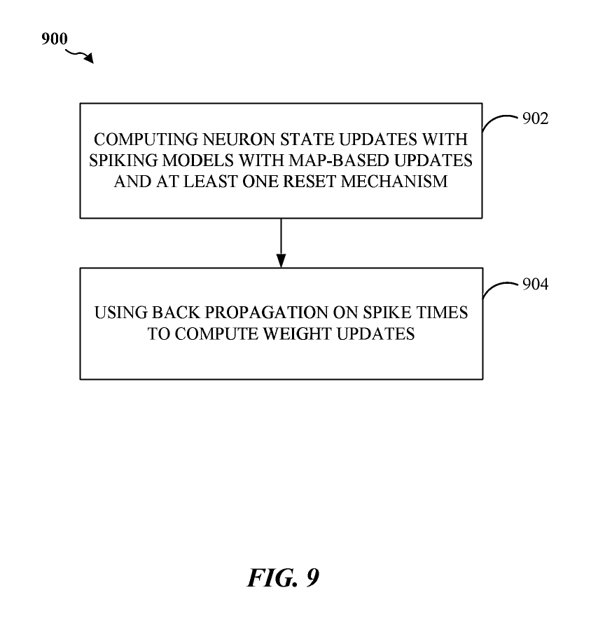

FIG. 9 illustrates a method 900 for training a spiking neural network. In block 902, the neuron model computes neuron state updates with spiking models with map-based updates and at least one reset mechanism. Furthermore, in block 904, the neuron model uses back propagation on spike times to compute weight updates.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices (e.g., a combination of a DSP and a microprocessor, a plurality of microprocessors, one or more microprocessors in conjunction with a DSP core, or any other such configuration).

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for training a spiking neural network, comprising:
computing neuron state updates with spiking models with map based updates and at least one reset mechanism; and
using back propagation on spike times to compute weight updates.

2. The method of claim 1, in which computing the neuron state updates is based at least in part on differential equation updates.

3. The method of claim 2, in which computing the neuron state updates is based at least in part on Cold neuron model updates.

4. The method of claim 1, in which the at least one reset mechanism triggers a reset based at least in part on a threshold.

5. The method of claim 1, in which the weight updates comprise modifying at least one weight based at least in part on an output spike time.

6. The method of claim 1, in which computing the weight updates includes adding an error term based at least in part on a neuron state at a spike time in the spiking neural network.

7. The method of claim 6, in which the neuron state and the spike time are of the same neuron.

8. The method of claim 1, in which the weight updates comprise default update values when a neuron does not spike or when a neuron spikes after a desired output spike time and actual output spike time.

9. The method of claim 1, further comprising normalizing a computed gradient when it exceeds a threshold.

10. The method of claim 1, in which computing neuron state updates comprises calculating neuron state updates based at least in part on closed form solutions.

11. An apparatus for performing back propagation in a spiking neural network, comprising:
means for computing neuron state updates with spiking models with map based updates and at least one reset mechanism; and
means for using back propagation on spike times to compute weight updates.

12. A computer program product for performing back propagation in a spiking neural network, comprising:
a non-transitory computer readable medium having encoded thereon program code, the program code comprising:
program code to compute neuron state updates with spiking models with map based updates and at least one reset mechanism; and
program code to use back propagation on spike times to compute weight updates.

13. An apparatus for performing back propagation in a spiking neural network, comprising:
a memory; and
at least one processor coupled to the memory, the at least one processor being configured:
to compute neuron state updates with spiking models with map based updates and at least one reset mechanism; and
to use back propagation on spike times to compute weight updates.

14. The apparatus of claim 13, in which the at least one processor is further configured to compute the neuron state updates based at least in part on differential equation updates.

15. The apparatus of claim 14, in which the at least one processor is further configured to compute the neuron state updates based at least in part on Cold neuron model updates.

16. The apparatus of claim 13, in which the at least one reset mechanism triggers a reset based at least in part on a threshold.

17. The apparatus of claim 13, in which the at least one processor is further configured to compute weight updates by modifying at least one weight based at least in part on an output spike time.

18. The apparatus of claim 13, in which the at least one processor is further configured to compute the weight updates by adding an error term based at least in part on a neuron state at a spike time in the spiking neural network.

19. The apparatus of claim 18, in which the neuron state and the spike time are of the same neuron.

20. The apparatus of claim 13, in which the at least one processor is further configured to compute weight updates as default update values when a neuron does not spike or when a neuron spikes after a desired output spike time and actual output spike time.

21. The apparatus of claim 13, in which the at least one processor is further configured to normalize a computed gradient when it exceeds a threshold.

22. The apparatus of claim 13, in which the at least one processor is further configured to compute neuron state updates by calculating neuron state updates based at least in part on closed form solutions.
